(19) United States
(12) Patent Application Publication
(10) Pub. No.: US 2024/0270943 A1
(43) Pub. Date: Aug. 15, 2024

(54) GELLING CITRUS FIBERS AND METHODS OF MANUFACTURE

(71) Applicant: CORN PRODUCTS DEVELOPMENT, INC., WESTCHESTER, IL (US)

(72) Inventors: Marjorie WELCHOFF, Bridgewater, NJ (US); Kelly CARVER, Bridgewater, NJ (US); Massoud GHASEMZADEH-BARVARZ, Bridgewater, NJ (US); Stella COUTROS-HOFFMANN, Bridgewater, NJ (US); Matthew CROWE, Bridgewater, NJ (US); Julie HIRSCH, Bridgewater, NJ (US); Senghane DIENG, Bridgewater, NJ (US); Carlos LUCERO, Bridgewater, NJ (US); John TZENG, Bridgewater, NJ (US); Jelena MEDIC, Bridgewater, NJ (US)

(21) Appl. No.: 18/568,399

(22) PCT Filed: Jun. 7, 2022
(86) PCT No.: PCT/US2022/032533

§ 371 Date: Dec. 8, 2023

Related U.S. Application Data
(60) Provisional application No. 63/208,123, filed on Jun. 8, 2021.

(51) Int. Cl. C08L 5/06; C08J 3/075; C08L 1/02

(52) U.S. Cl. CPC C08L 5/06; C08J 3/075; C08L 1/02; C08J 2301/02; C08J 2305/06; C08L 2201/54

(57) ABSTRACT

The technology disclosed in this specification pertains to pectin containing cellulosic materials. The cellulosic material is modified so that it can form strong gels when dispersed in aqueous solution. Also disclosed are methods for modifying the cellulosic materials, including, at least in some embodiments, methods to monitor changes in the infrared spectrum of the cellulosic material that happen during a modification reaction to control the reaction and obtain end products capable of making gels having the desired gel strength.

The technology disclosed in this specification pertains to pectin containing cellulosic materials derived from citrus peels. The cellulosic material is modified so that it can form strong gels when dispersed in aqueous solution. Also disclosed are methods for modifying the cellulosic materials, including, at least in some embodiments, methods to monitor changes in the infrared spectrum of the cellulosic material that happen during a modification reaction to control the reaction and obtain end products capable of making gels having the desired gel strength.

Pectin, a heteropolysaccharide that is rich galacturonic acid, is obtained from protopectin, a material which is associated with the cell walls and the middle lamella matrices in plants (called in this specification pectin containing cellulosic material). Pectin forms from the acidic hydrolysis of protopectin, and pectin is a useful thickening agent in the presence of water, sugar and calcium ions. The ability of some pectin to thicken aqueous solution or form gels is limited by methyl-esters attached to the polysaccharide backbone. So commonly, to broaden pectin's native utility, protopectin is extracted using acid and is also commonly at least partially de-esterified by incubating the citrus peel in alkaline solution.

Variations on the basic extraction reactions and desertification reactions are described in the art. Some variations make pectin containing cellulosic material. But there remains a need for pectin containing cellulosic materials that forms strong gels. This specification describes pectin containing cellulosic materials obtained by modifying pectin containing cellulosic material, preferably citrus peel, to form a product that forms strong gels. The product comprises a pectin component within a cellulosic matrix. The product has a defined degree of esterification, a defined a molecular weight, and can form strong gels in aqueous solution. While the principles described in this specification can be applied generally to pectin (or protopectin rich cellulosic materials), in preferred embodiments the material is made from citrus peel. Within this specification preferred embodiments made from citrus fiber are called gelling citrus fiber material. Also disclosed in this specification are methods of making the gelling citrus fiber material and methods of controlling the methods of making gelling citrus fiber material.

The technology disclosed in this specification can be better understood with reference to the following non-limiting figures.

### BRIEF DESCRIPTION OF THE FIGURES

FIG. 1 depicts a flow diagram of an embodiment of a method for making a gelling citrus fiber.

FIG. 2 is a block diagram illustrating an embodiment of a method for making a gelling citrus fiber material and methods for controlling the method of making a gelling citrus fiber material.

In an aspect, this specification discloses a gelling citrus fiber material. In any embodiment a gelling citrus fiber material comprises a cellulosic component and a pectin component has a percent galacturonic acid of from about 40% to about 50% (% GA), or from about 40% to about 48%, or about 40% to about 46%, or about 42% to about 48%, or about 42% to about 46%, the pectin component having degree of esterification of from about 10 to about 80%, and the gelling citrus fiber material having a molecular weight of from about 50 kDa to about 275 kDa. The gelling citrus fiber material is derived from peels of citrus fruit, and any citrus fruit may be used. In some embodiments the citrus fruit is selected from the group consisting of lemons, limes, oranges and mixtures thereof. In preferred embodiment the gelling citrus fiber material is obtained from the orange peels, which may be from a single orange variety or mixture of orange varieties.

Within this specification gelling citrus fiber comprising a cellulosic component and a pectin component refers to material wherein the cellulosic component and pectin component are not merely mixtures of pectin and cellulose. Instead, the cellulosic component and pectin component are associated in some way. The manner of association is not limited but at least refers to some physical association that holds the pectin component and cellulosic component together. In at least some embodiments of the gelling citrus fiber material, the cellulosic component forms a matrix and at least part of the pectin component is within the cellulosic matrix.

This specification further defines separate embodiments of gelling citrus fiber each embodiment having a defined range of degree of esterification (% DE). In one range, a gelling citrus fiber material has a pectin component having a degree of esterification of from about 30% to about 45% (% DE), or from about 35% to about 45%, or from about 37% to about 45%. In a second range, a gelling citrus fiber material has a pectin component having a degree of esterification of from about 46% to about 55% (% DE), or from about 47% to about 52%, or from about 47% to about 50%. In a third range, a gelling citrus fiber material has a pectin component having a degree of esterification of from about 10% to about 20% (% DE), or from about 10% to about 18%, or from about 10% to about 15%. In a fourth range, a gelling citrus fiber material has a pectin component having a degree of esterification of from about 60% to about 65% (% DE), or from about 60% to about 63%.

The various embodiments, the gelling citrus fibers described in this specification are described by a range of molecular weights. In one range, a gelling citrus fiber material has a molecular weight of from about 50 to about 200 kDa, or from about 50 to about 150 kDa, or from about 50 to about 125 kDa, or from about 50 to about 100 kDa. In a second range, a gelling citrus fiber material has a desired molecular weight from about 200 kDa to about 300 kDa, or from about 210 k Da to about 275 kDa, or from about 210 kDa to about 265 kDa, or from about 225 kDa to about 265 kDa, or from about 230 kDa to about 260 kDa. In a third range, a gelling citrus fiber material has a desired molecular weight from 100 kDa to about 200 kDa, or from about 100 kDa to about 150 kDa, or from about 100 kDa to about 125 kDa.

The gelling citrus fiber material described in this specification is also described by the combination of degree of esterification and molecular weight. In one set of ranges, a gelling citrus fiber material has a pectin component having degree of esterification of from about 30% to about 45% (% DE), or from about 35% to about 45%, or from about 37% to about 45%, and a molecular weight of the material from about 50 to about 200 kDa, or from about 50 to about 150 kDa, or from about 50 to about 125 kDa, or from about 50 to about 100 kDa. In a second set of ranges a gelling citrus fiber material has a pectin component having a degree of esterification from about 46% to about 55% (% DE), or from about 47% to about 52%, or from about 47% to about 50% and a molecular weight of the material from about 200 kDa to about 300 kDa, or from about 210 kDa to about 275 kDa, or from about 210 kDa to about 265 kDa, or from about 225 kDa to about 265 kDa, or from about 230 kDa to about 260 kDa. In a third set of ranges, a gelling citrus fiber material has a pectin component having a degree of esterification from about 10% to about 20% (% DE), or from about 10% to about 18%, or from about 10% to about 15%, and a molecular weight of the material from 100 kDa to about 200 kDa, or from about 100 kDa to about 150 kDa, or from about 100 kDa to about 125 kDa. In a fourth set of ranges, a gelling citrus fiber has a pectin component having a degree of esterification from about 60% to about 65% (% DE), or from about 60% to about 63%, a molecular weight of the material from 100 kDa to about 200 kDa, or from about 100 kDa to about 150 kDa, or from about 100 kDa to about 125 kDa.

The set of degree of esterification ranges and molecular weight ranges correlate to defined ranges of gel strength of gels obtainable by using the disclosed gelling citrus fiber materials. To illustrate these ranges, this specification defines test gels, using standardized aqueous solution, standardized gelling citrus fiber material, and standardized method of manufacture. The test gel is useful for comparing obtainable gel strengths, but otherwise is an illustrative non-limiting embodiment of a gel made from the gelling citrus fiber material described in this specification. In one set of embodiments described in this specification, a gelling citrus fiber material can form a test gel having gel strength of greater than about 200 g, or from about 200 g to about 500 g, or from about 225 g to about 500 g, or from about 275 g to about 500 g, or from about 300 g to about 500 g, or from about 300 g to about 400 g. In a second set of embodiments, a gelling citrus fiber material can form a test gel having gel strength of less than about 200 g, or from about 100 g to about 200 g, or from about 110 g to about 180 g, or from about 125 g to about 175 g, or from about 130 g to about 170 g. In third set of embodiments described in this specification, a gelling citrus fiber material can form a test gel having gel strength of less than about 100 g, or from about 10 g to about 100 g, or from about 20 g to about 100 g, or from about 25 g to about 100 g, or from about 25 g to about to about 80 g, or from about 25 g to about 75 g.

With further reference to specific sets of embodiments described in this specification, a gelling citrus fiber material having a the molecular weight range from about 50 to about 200 kDa, or from about 50 to about 150 kDa, or from about 50 to about 125 kDa, or from about 50 to about 100 kDa and having a pectin component having a degree of esterification range of from about 30% to about 45% (% DE), or from about 35% to about 45%, or from about 37% to about 45% can form a test gel having gel strength of greater than about 200 g, or from about 200 g to about 500 g, or from about 225 g to about 500 g, or from about 275 g to about 500 g, or from about 300 g to about 500 g, or from about 300 g to about 400 g.

In another set of embodiments, described in this specification, a gelling citrus fiber material having a molecular weight range of greater than about 200 kDa to about 300 kDa, or from about 210 k Da to about 275 kDa, or from about 210 kDa to about 265 kDa, or from about 225 kDa to about 265 kDa, or from about 230 kDa to about 260 kDa and having a pectin component having degree of esterification from about 46% to about 55% (% DE), or from about 47% to about 52%, or from about 47% to about 50% and can form a test gel having a gel strength that is less than about 200 g, or from about 100 g to about 200 g, or from about 110 g to about 180 g, or from about 125 g to about 175 g, or from about 130 g to about 170 g.

In still another set of embodiments described in this specification, a gelling citrus fiber material having a molecular weight of from 100 kDa to about 200 kDa, or from about 100 kDa to about 150 kDa, or from about 100 kDa to about 125 kDa and a pectin component having a degree of esterification from about 10% to about 20% (% DE), or from about 10% to about 18%, or from about 10% to about 15%; and can form a test gel having gel strength of less than about 100 g, or from about 10 g to about 100 g, or from about 20 g to about 100 g, or from about 25 g, to about 100 g, or from about 25 g to about to about 80 g, or from about 25 g to about 75 g.

In yet still another set of embodiments described in this specification, a gelling citrus fiber material having a molecular weight of from 100 kDa to about 200 kDa, or from about 100 kDa to about 150 Kda, or from about 100 kDa to about 125 kDa, and a pectin component having a degree of esterification of from about 60% to about 65% (% DE), or from about 60% to about 63%, and can form a test gel having gel strength of less than about 100 g, or from about 10 g to about 100 g, or from about 20 g to about 100 g, or from about 25 g, to about 100 g, or from about 25 g to about to about 80 g, from about 25 g to about 75 g.

The gelling citrus fiber materials disclosed in this specification are useful for modifying the texture of a composition, including for compositions for industrial uses, home care uses, personal care uses, or other nonedible uses, or are useful in food compositions. Use of a gelling citrus fiber material to modify the texture of a composition or food composition includes the use of the gelling citrus fiber material to form a gel or a composition comprising a gel. Any embodiment of a gelling citrus fiber material disclosed in this specification is useful to modify the texture of a composition or food composition. In any embodiment disclosed in this specification, a gelling citrus fiber is used as a gelling agent or to form a gel in a composition or a food composition. Gelling citrus fibers described in this specification can be used in any amount desirable, but most commonly are used in amount of from about 0.1% to about 10% or from 0.5% to about 5% of the composition. or from about 1.5% to 4.5%, or from about 2.5% to about 3.5%.

This specification also discloses compositions and food compositions comprising a gelling citrus fiber material used in any amount. In preferred embodiments a food composition described in this specification includes a gelling citrus fiber material in an amount from about 0.1% to about 10% (by weigh of the composition) or from 0.5% to about 5%, or from about 1.5% to 4.5%, or from about 2.5% to about 3.5%. In any embodiment disclosed in this specification, a composition or a food composition includes a gelling citrus fiber material as described in any embodiment in this specification and a second ingredient. In any embodiment disclosed in this specification, a composition or a food composition includes a gelling citrus fiber and an aqueous ingredient. In any embodiment disclosed in this specification, a composition or a food composition includes a gelling citrus fiber material an aqueous ingredient and at least one other ingredient. In any embodiment disclosed in this specification, a food composition includes a gelling citrus fiber and an edible aqueous ingredient. In any embodiment disclosed in this specification, a food composition includes a gelling citrus fiber material, an edible aqueous ingredient, and at least one other edible ingredient.

In any embodiment of a food composition disclosed in this specification, includes the gelling citrus fiber material and any second ingredient used in food compositions. In any embodiment described in this specification, a food composition includes a starch including but not limited to corn starch, tapioca starch, pea starch, fava bean starch, lentil starch, chickpea starch, tapioca starch, potato starch, and sago starch as well as high amylose and low amylose variants of such starches. Such starches also may be within flours and meals including wheat flour, tapioca flour, rice flour, and corn meal. Useful starches may be modified or unmodified. Modified starches may be crosslinked including by using phosphate or adipate, or may be stabilized, including hydroxypropylation and acetylation. Useful starch may be converted or hydrolyzed using shear, enzyme, acid, chemicals, or oxidation. Starch may also be modified usefully by oxidation for purposes other than hydrolysis. Useful starch may be physically modified such as by thermal inhibition, annealing, or heat moisture treatments. Modified and unmodified starch may be pregelatinized or otherwise made cold water soluble.

In any embodiment, a food composition including a gelling citrus fiber material described in this specification may further comprise a sweetener. Useful sweeteners include dextrose, allulose, tagatose, fructose, glycerol, sucrose, erythritol, rebaudiosides (A, B, J, M, etc.), and glucosylated stevia glycosides, and corn syrups including high fructose corn syrups. Sweeteners may be provided in solid, or powdered, or liquid, or syrup form.

In any embodiment, a food composition including a gelling citrus fiber material as described in this specification may further comprise a gum or gum-like material. Useful gums and gum like materials include gelling starches, gum Arabic, xanthan gum, tara gum, konjac, carrageenan, locust bean gum, gellan gum, guar gum, and mixtures thereof.

In any embodiment, a food composition including a gelling citrus fiber material as described in this specification may further comprise an oil, or fat, or aqueous ingredient. Useful oils include vegetable oils such as corn oil, olive oil, canola oil, sunflower oil, rapeseed oil, palm oil, coconut oil. Useful fats (other than vegetable oils) included animal fats and dairy fats. Useful aqueous ingredients include water, milk, syrups, or other carbohydrate containing liquids, or acidic liquids, or basic liquids.

In any embodiment, a food composition including a gelling citrus fiber material as described in this specification may further comprises various other flavorings, seasonings and colorings commonly used in food composition.

In any embodiment, a food composition including a gelling citrus fiber material is any food composition. In any embodiment, a food composition including a gelling citrus fiber material is a gelled food composition. In any embodiment, a food composition including a gelling citrus fiber material is selected from the group comprising (but is not limited to) cereal, bread and bread products, cheese and imitation cheese products, condiments, confectioneries, dressings including pourable dressings and spoonable dressings, pie fillings including fruit filings (and other similar fruit preparations whether used in pies) and cream fillings, sauces, including white sauces and dairy-based sauces such as cheese sauces, gravies, imitation and lite syrups, puddings, custards, yogurts, sour creams, pastas, beverages including dairy-based beverages, glazes, soups and baby food.

In another aspect, this specification also discloses methods for making a gelling citrus fibers material, which conform to any embodiment described in this specification. Within this specification, any embodiment of a method for making a gelling citrus fiber material as described comprises: mixing a comminuted citrus peel comprising a pectin component and a cellulosic component with an acidic solution to obtain an acid washed citrus peel; mixing the acid washed citrus peel with an alkaline solution to reduce the degree of esterification (% DE) of the pectin component thereby obtaining de-esterified citrus peel; recovering the de-esterified citrus peel to obtain the gelling citrus fiber material.

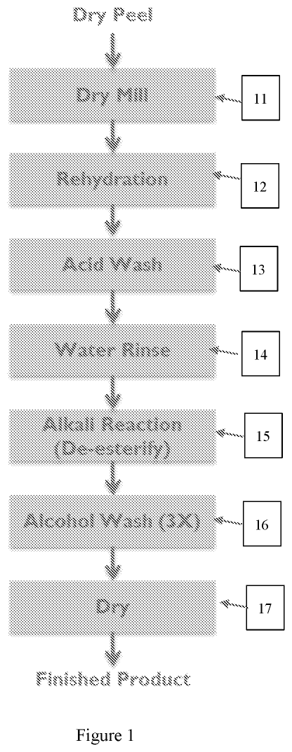

Another embodiment of a method for making a gelling citrus fiber material is depicted, as a flow diagram, in FIG. 1. Citrus peel is comminuted by any suitable method and can be obtained as a raw material from dry peel or fresh peel. Peels can be rehydrated before or after milling, and the rehydration before the acid step is optional. With reference, to FIG. 1, the process begins with dry peel which is dry milled to desired size in a step (11). The milled citrus peel is rehydrated in a step (12) using water or aqueous solution. The rehydrated comminuted citrus peel is acid washed in step (13) and acid is washed out of the citrus peel in water rinse step (14). The acid washed material is the subjected to an alkaline incubation that reduces degree of esterification, to “de-esterify” the acid washed citrus peel in a step (15). The de-esterified citrus peel (which is the gelling citrus fiber) is then washed in alcohol wash step (16), preferably three times, and the dried in drying step (17) to recover the final product.

Variations on the above process are possible for example, alcohol wash is useful for reducing ash content or salts content of the gelling citrus fiber but is not strictly necessary to obtain a gelling citrus fiber material that can form gels of desired gel strength. As such, the number of times the gelling citrus fiber material is washed can be adjusted as needed to obtain a desired ash or salt content.

Notably, in a preferred embodiment the acid wash is run in an aqueous solution (not an acidic alcohol solution). Pectin, being soluble in water, requires that care is taken to reduce the amount of pectin that washes out of the cellulosic material during the acid wash. For example, as described below, the acid was applied at a temperature, a pH and for a time, such that substantial pectin that remained associated with the gelling citrus fiber after the acid wash and water rinse steps.

As described in this specification, gelling citrus fiber material can be described with reference to its molecular weight. The acid wash and alkaline incubation both can contribute to reducing the molecular weight of the raw material to obtain the desired molecular weight of the gelling citrus fiber. Preferably, however, the alkaline incubation is controlled so that it does not substantially further alter the molecular weight of the material compared to the acid washed citrus peel. In other words, preferably, most of the molecular weight reduction of the citrus peel done to obtain the gelling citrus fiber occurs during the acid wash step. As to specific reaction conditions, in any embodiment described in this specification, a comminuted citrus peel is mixed with an acidic solution having a pH of less than 3, or from about 1.5 to about 2.5. In any embodiment of a gelling citrus fiber material disclosed in this specification, comminuted citrus peel is mixed with an acidic solution for less than about 90 minutes, or less than about 60 minutes, or from about 10 minutes to about 90 minutes, or from about 30 to about 90 minutes, or from about 10 minutes to about 60 minutes, or from about 30 to about 60 minutes. Ranges of embodiments of the gelling citrus fiber material can be obtained by subjecting the citrus peel to acid wash for a more narrowly defined time. In one range of embodiments, in a method for making a gelling citrus fiber material, comminuted citrus peel is mixed with an acidic solution for about 10 minutes to about 30 minutes. In another set of embodiments of a method for making a gelling citrus fiber material, comminuted citrus peel is mixed with an acidic solution from about 30 minutes to about 50 minutes. In a third set of embodiments of a method for making a gelling citrus fiber material, comminuted citrus peel is mixed with an acidic solution from about 50 minutes to about 70 minutes. Useful acids for creating an acidic solution include any food grade acid capable of producing a solution having the desired pH and include but are not limited to mineral acids such as hydrochloric acid.

In any embodiment of a method for making a gelling citrus fiber material disclosed in this specification, mixing a comminuted citrus peel with an acidic solution forms an acid washed citrus peel. In any embodiment of a method for making a gelling citrus fiber material disclosed in this specification, following mixing a comminuted citrus peel with an acidic solution, the method includes dewatering, by any suitable means, an acid washed citrus peel including, for example, centrifugation and filtration.

Acid washed citrus peel is further reacted in an alkaline solution (within this specification the resulting product is called a (“de-esterified citrus peel”). As said, the alkaline incubation may further reduce the molecular weight of the acid washed citrus peel but in preferred embodiments is designed so that the relative molecular weight change is small (citrus peel to acid incubated citrus peel compared to acid washed citrus peel to de-esterified citrus peel). In any embodiment, during the alkaline incubation, an acid washed citrus peel is mixed with an alkaline solution (aqueous solution) at a chosen temperature and at a chosen pH to controllably reduce the degree of esterification of the acid washed citrus peel. In embodiments the pH of the alkaline incubation is greater than about 8 or greater than about 8.5 so that de-esterification can occur but is below 11 so that de-esterification can be controlled to obtain a desired degree of esterification. In a preferred embodiment, the pH of the alkaline incubation is from about 9 to about 10.

Temperature is also important for controlling the rate of the de-esterification reaction. In a broad range of embodiments, the temperature from for the de-esterification reaction is from about 1° C. to about 30° C. Within this range, temperatures are chose based on the intended target range degree of esterification for the end-product. In one range of embodiments, an acid washed citrus peel is mixed with an alkaline solution at a temperature from about 1° to about 10° C., or from about 3° C. to about 7° C. to reduce the degree of esterification. In another range of embodiments for making a gelling citrus fiber material, an acid washed citrus peel is mixed with an alkaline solution at a temperature from about 10° C. to about 20° C. or from about 12° C. to about 17° C. to reduce the degree of esterification. In a third set of embodiments, a method for making gelling citrus fiber material, an acid washed citrus peel is mixed with an alkaline solution at a temperature from about 20° C. to about 30° C. or from about 22° C. to about 27° C. In any embodiment of a method of making a gelling citrus fiber material disclosed in this specification, mixing an acid washed citrus peel with an alkaline solution obtains a material including a cellulosic component and a de-esterified pectin component. Following the alkaline incubation to reduce the degree of esterification of pectin component, the de-esterified citrus peel is recovered using common mean in the art such as drying, filtering, centrifugation, and mixtures thereof.

In at least some embodiments, disclosed in this specification, a method for making a gelling citrus fiber material includes washing a de-esterified citrus peel using an organic solvent, preferably alcohol. The material may be washed more than once, for example two times or three times, or more. The washing step is not strictly necessary but reduces the salt or ash content of the final product. Following washing the material, the solvent is removed using any suitable method including centrifugation, filtration and evaporation and mixtures thereof. As said, preferably, the organic solvent is alcohol, and while any food grade organic solvent can be used, a preferred solvent is ethanol.

In another aspect, this specification discloses methods for monitoring a chemical reaction involving a material comprising a pectin component and a cellulosic component in order to obtain a gelling citrus fiber material. The reactions are monitored using infrared (“IR”) spectroscopy and preferable Fourier transform infrared (“FTIR”) spectroscopy and are based on changes in key ranges of wavenumbers that occur during one or more step of a method to obtain a gelling citrus fiber material. For example, in at least some embodiments described in this specification a set of chemical reactions for modifying the cellulosic component and pectin component of citrus peel includes an acid wash step that reduces the molecular weight of the starting material. In another example, in at least some embodiments described in this specification a set of chemical reactions for modifying the cellulosic component and pectin component of citrus peel includes an alkaline incubation that de-esterifies the citrus peel. In another example, the gelling citrus fiber material comprises a pectin component as measured by the percent galacturonic acid and changes of galacturonic acid are measured, for example during one or more of the acid wash, alkaline incubation and alcohol wash.

In preferred embodiments the infrared spectral changes of the alkaline incubation are monitored, and de-esterification can be controlled to obtain a desired degree of esterification. In one embodiment this specification describes a method of measuring a chemical reaction involving a material comprising a pectin component and a cellulosic component, the method comprising recording a spectrum of the material; and evaluating the spectrum against a model that correlates the spectrum against a second parameter of one or more of the pectin component or cellulosic component wherein the spectrum is evaluated at least a within wavenumber range selected from the group consisting of: a wavenumber range from about 1400 to about 850 cm⁻¹, one or more wavenumber ranges selected of the group consisting of (A) about 1400 to 1050 cm⁻¹, (B) 1050 to 975 cm⁻¹, (C) 975 to 875 cm⁻¹, and (D) 875 and about 850 cm⁻¹, and one or more wavenumber ranges selected from the group consisting of (A) about 1095 to about 1070 cm⁻¹, (B) about 1050 to about 1020 cm⁻¹, (C) about 975 to about 895 cm⁻¹, and (D) about 875 to about 845 cm⁻¹ wherein, preferably, the chemical reaction converts the material to a gelling citrus fiber.

With reference to the wavenumber ranges used to make the model. The model can be created by recording or measuring a wider range of wavenumbers. For example a model can be constructed by monitoring wavenumbers between 3500-650 cm⁻¹ or even broader ranges. Narrower wavenumber ranges, such as those described above, are selected based on how well they can be used to develop a model to predict a parameter of interest in the gelling citrus fiber material.

With reference to the step of recording a spectrum of the material and evaluating the spectrum against a model that correlates the spectrum against a second parameter of the pectin component, the second parameter can be any useful parameter that can be correlated against a change in spectrum measurable using infrared spectroscopy, such parameters include percent galacturonic acid, or degree of esterification, or molecular weight of the in the gelling citrus fiber material. In a preferred embodiment the second parameter is the degree of esterification. Degree of esterification can be measured using titration processes described, for example, by Schultz (1965) (“Determination of the degree of esterification of pectin, determination of the ester methoxyl content of pectin by saponification and titration. Determination of the anhydro uronic acid content by decarboxylation and titration of the liberated carbon dioxide.” In: Whistler R L, Wolfrom M L (eds) Methods in carbohydrate chemistry, vol 5. Academic Press, New York) and Lin et al. (1990) (“Quantification of methyl ester content of pectin by pectinesterase.” Botanical Bulletin of Academia Sinica: Vol 31. Page 273-278. Variations of these methods are possible, and the method can be adapted to specific needs. As used in this specification, generally, the method can be divided into two parts: (1) washing the material and (2) double titration. Washing the sample removes any salts, sugars and counter-ions using acidic alcohol to ensure all the pectin is either in the esterified form or present as free acid. The first titration is used to determine the free acid groups and the neutral solution can then be used in the second titration method proposed by Schultz (1965). A detailed titration process useful for measuring degree of esterification is described in the methods section of the specification.

A model correlating an infrared spectrum and a second parameter can be developed using any suitable process. In one embodiment samples of a chemical reaction mixture are analyzed at defined times. At these times both the second parameter and the spectrums a measured. Samples are correlated using statistical analysis that correlates changes in parameter with changes in the spectrums. In at least one embodiment, a wide range of de-esterified samples are obtained. Although any number of samples can be used to develop a model, more accurate models are developed with more samples. With reference to a model correlating changes in IR spectrums with measured degree of esterification, degree of esterification can be measured using a titration method and statistical analysis, for example a partial least squares regression model, can be used to correlated spectrums with the degree of esterification. Other regressions algorithms can be used and or modified with the skill of the art to construct useful models for monitoring reactions described herein including principle component regression, multilinear regression, or neural networks.

Spectrums for producing a model or predicting the value of a desired parameter of gelling citrus fiber material, for example, degree of esterification, can be recorded using a probe in a reaction vessel. The probe can be set up to measure spectrums and send the measured spectrums to a measuring means for use in producing the model or predicting the desired parameter of a reaction material, for example a cellulosic component or pectin component. In various embodiments one parameter of the chemical reaction being monitored can be altered based on the predicted value of a parameter of the reaction material. For example, in a preferred embodiment a calculating means predicts the degree of esterification of a pectin component during an alkaline de-esterification by comparing at least part of a measured spectrum taken from a probe in the de-esterification reaction vessel to a de-esterification model. If the predicted degree of esterification matches a desired degree of esterification, the calculating means may signal a control means to stop the de-esterification reaction, for example, by reducing the pH in the reaction vessel to stop the de-esterification reaction.

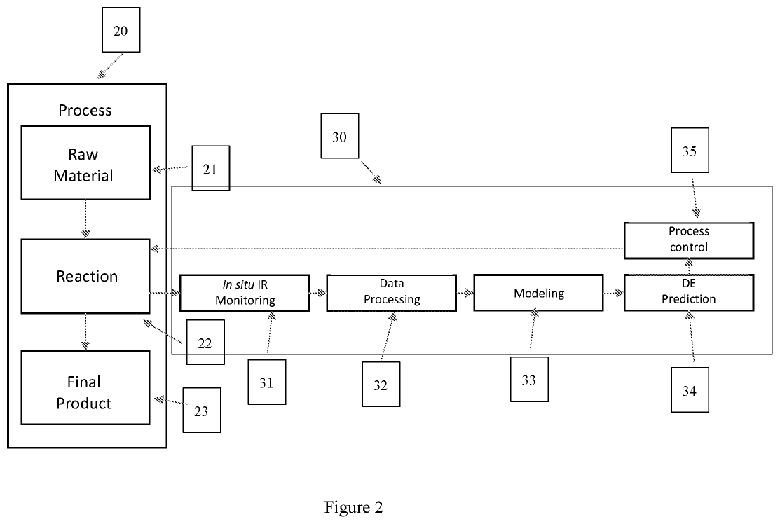

A block diagram of an embodiment of a process for monitoring and controlling a process for making a gelling citrus fiber is depicted in FIG. 2. With reference to a process (20) for making a gelling citrus fiber material, raw material is provided in a step (21), the raw material is modified in a reaction step (22), and a final product is recovered in a step (23). In one embodiment, the reaction step is characterized as combining one or more of an acid wash step, a de-esterification step, and an alcohol wash step. In one embodiment, the reaction step is characterized as combining one or more steps to reduce the molecular weight of a raw material, and one or more steps to de-esterify a raw material.

With further reference to FIG. 2, the process for monitoring a process for obtaining a gelling citrus fiber material comprises monitoring (30) the reaction by an in situ IR (infrared) monitoring step (31), a data processing step (32), a modeling step (33), a DE (degree of esterification) prediction step (34), and a process control (35) step. In application these steps may blend or overlap or be combined into fewer steps. Generally, speaking, and in reference to the steps described in FIG. 1, IR spectrum is monitored and recorded. The IR data is processed to at least obtain an IR spectrum that can be correlated against a DE prediction model, which allows for predicting the degree of esterification of the reaction material at the time of measurement. Using the predicted DE the process can be controlled by adjusting at least one parameter of the reaction, for example by adjusting the pH of the reaction to stop de-esterification.

In other embodiments, spectrums for producing a model or predicting a desired parameter of a gelling citrus fiber material, for example, degree of esterification, can be recorded from a sample obtained during a chemical reaction. In such embodiments, samples of reaction fluid are extracted, and the modified starting material is recovered and placed on a probe to measure its spectrum. The measured spectrum is then used to develop a prediction model or the prediction model is applied by calculating means to use IR spectrum to predict the degree of esterification. While the samples collect in this way are not real time, compared to titration methods for calculating degree of esterification, the prediction model is a faster and less chemically intensive means for determine the degree of esterification of a sample.

Machinery and means for correlating spectrums with measured values of a parameter, for predicting a value of desired parameter from the model, or for controlling a chemical reaction include any suitable processing device or system, including computers, microprocessors, and distributed computing systems. Machinery and means for communicating spectrums, parameter predictions, or control signals based on the spectrums or predictions (such communication being for any purposes) include wired and wireless communications means using any communication protocol.

Non-limiting examples and further description of these means include machinery having a human-machine interface (HMI), which can be an integral part of the system, or can be housed generally as part of any computer and/or processing device. Whether including an HMI, non-limiting examples of such a device, means or machinery may be central processing units alone or in tablets, telephones, handheld devices, laptops, user displays, or generally any other computing device capable of allowing input, providing options, and showing output of electronic functions. A central processing unit (CPU), also called a central processor or main processor, is the electronic circuitry within a computer that carries out the instructions of a computer program by performing the basic arithmetic, logic, controlling, and input/output (I/O) operations specified by the instructions. Still further examples include a microprocessor, a microcontroller, or another suitable programmable device and a memory. The controller also can include other components and can be implemented partially or entirely on a semiconductor (e.g., a field-programmable gate array (“FPGA”)) chip, such as a chip developed through a register transfer level (“RTL”) design process.

An HMI may incorporate a display, which may be informational or allow for inputs, such as a user interface (UI) or a graphical user interface (GUI). A user interface is how the user interacts with a machine. The user interface can be a digital interface, a command-line interface, a graphical user interface (“GUI”) or any other way a user can interact with a machine. For example, the user interface (“UI”) can include a combination of digital and analog input and/or output devices or any other type of UI input/output device required to achieve a desired level of control and monitoring for a device. Examples of input and/or output devices include computer mice, keyboards, touchscreens, knobs, dials, switches, buttons, etc. Input(s) received from the UI can then be sent to a microcontroller to control operational aspects of a device.

The user interface module can include a display, which can act as an input and/or output device. More particularly, the display can be a liquid crystal display (“LCD”), a light-emitting diode (“LED”) display, an organic LED (“OLED”) display, an electroluminescent display (“ELD”), a surface-conduction electron emitter display (“SED”), a field-emission display (“FED”), a thin-film transistor (“TFT”) LCD, a bistable cholesteric reflective display (i.e., e-paper), etc. The user interface also can be configured with a microcontroller to display conditions or data associated with the main device in real-time or substantially real-time.

According to any of the embodiments described in the specification, HMI or other calculating or controlling device, means, or machine may also include or otherwise be operatively connected to a memory, which can store data associated with the system. Such data can be used to operate the system in the dynamically variable manner to include past information and tables, such that the system could “look up” past data to more efficiently operate. The memory includes, in some embodiments, a program storage area and a data storage area. The program storage area and the data storage area can include combinations of different types of memory, such as read-only memory (“ROM”, an example of non-volatile memory, meaning it does not lose data when it is not connected to a power source) or random access memory (“RAM”, an example of volatile memory, meaning it will lose its data when not connected to a power source). Some additional examples of volatile memory include static RAM (“SRAM”), dynamic RAM (“DRAM”), synchronous DRAM (“SDRAM”), etc. Additional examples of non-volatile memory include electrically erasable programmable read only memory (“EEPROM”), flash memory, a hard disk, an SD card, etc. In some embodiments, the processing unit, such as a processor, a microprocessor, or a microcontroller, is connected to the memory and executes software instructions that are capable of being stored in a RAM of the memory (e.g., during execution), a ROM of the memory (e.g., on a generally permanent basis), or another non-transitory computer readable medium such as another memory or a disc.

The HMI, controlling, calculating device, machinery, or means whether separate or integral with the system, could be powered in many ways. The power supply outputs a particular voltage to a device or component or components of a device. The power supply could be a DC power supply (e.g., a battery), an AC power supply, a linear regulator, etc. The power supply can be configured with a microcontroller to receive power from other grid-independent power sources, such as a generator or solar panel. With respect to batteries, a dry cell battery [or a wet cell battery] may be used. Additionally, the battery may be rechargeable, such as a lead-acid battery, a low self-discharge nickel metal hydride battery (LSD-NiMH) battery, a nickel-cadmium battery (NiCd), a lithium-ion battery, or a lithium-ion polymer (LiPo) battery. Careful attention should be taken if using a lithium-ion battery or a LiPo battery to avoid the risk of unexpected ignition from the heat generated by the battery. While such incidents are rare, they can be minimized via appropriate design, installation, procedures and layers of safeguards such that the risk is acceptable.

According to any of the embodiments described in the specification, the HMI, controlling or calculating device, means, or machinery as well as any of the components thereof, could be integral with the system, or could be standalone and separate. In either sense, one or more components of the HMI, controlling, or calculating device, means, or machinery could include network/communication components and protocol to allow for the transfer of information related to the system (30) to be communicated among and outside of the components of the system. This could include transfer of information to a central network of servers or other memory that stores particular operating information for later review and use. The information could also be transferred to one or more remote devices to allow for remote monitoring of the operation of the system without the need to be physically present. The information could also be utilized for fine-tuning of the operation of one or more sub-operations of the system to aid in increasing the efficiency of the system. Still further, it is contemplated that the one or more of the remote locations include machine-learning to allow the closed-loop, dynamically controlled system to self-improve.

According to any of the embodiments described in the specification, the network is, by way of example only, a wide area network (“WAN”) such as a TCP/IP based network or a cellular network, a local area network (“LAN”), a neighborhood area network (“NAN”), a home area network (“HAN”), or a personal area network (“PAN”) employing any of a variety of communications protocols, such as Wi-Fi, Bluetooth, ZigBee, near field communication (“NFC”), etc., although other types of networks are possible and are contemplated herein. The network typically allows communication between the communications module and the central location during moments of low-quality connections. Communications through the network can be protected using one or more encryption techniques, such as those techniques provided in the IEEE 802.1 standard for port-based network security, pre-shared key, Extensible Authentication Protocol (“EAP”), Wired Equivalent Privacy (“WEP”), Temporal Key Integrity Protocol (“TKIP”), Wi-Fi Protected Access (“WPA”), and the like.

According to any of the embodiments described in the specification, a device, such as the HMI could include one or more communications ports such as Ethernet, serial advanced technology attachment (“SATA”), universal serial bus (“USB”), or integrated drive electronics (“IDE”), for transferring, receiving, or storing data.

The methods and compositions of this specification have been described by reference to preferred embodiments made from citrus peel starting material. The methods may also be applied to other pectin containing cellulosic materials to obtain compositions have the degree of esterification, pectin content, and/or molecular weight describe in this specification. In the broadest sense substantially all plants comprise pectin containing cellulosic material, although some may not be suitable starting materials because they have pectin content (% GA) that is outside the ranges described in this specification. Useful starting material whole or comminuted fruits and vegetables, pomace from the creation of purees from apple, stone fruit like, peaches, apricots, nectarines, berries, such as blueberries, strawberries, raspberries, black berries, roots such as carrots and other similar fruits and vegetables, non-peel components of citrus fruit such as vesicles, fiber from other plant sources such as from legume hull or seed (including from pea, lentil, fava bean, chickpea), fiber waste from starch manufacture such as potato peel, tapioca peel, corn hull, rice bran etc. Fiber from plant leaves or leaf remnants of plants harvested for other purposes such as leaves from stevia plant.

The embodiments of gelling fiber material, gelling citrus fiber material, methods for making such material and method for monitoring reactions to make a such materials can be better understood with reference to the following definitions.

Reference in this specification to a “cellulosic component” means a component of a gelling material or gelling citrus fiber material comprised of cell walls or cell wall fragments of a plant or plant part, for example citrus peel. While not limited to any particular fragment of a cell wall, it is expected that the cellulosic component will comprise one or more of cellulose, cellulose fragments, and hemicellulose.

Reference in this specification to a “cellulosic matrix” means a cellulosic component that forms a structure or medium that comprises at least in part a pectin component.

Reference in this specification to a “pectin component” or “pectin” means a galacturonic acid rich polysaccharide that is one or more of protopectin, pectin, and pectic acid and that is associated with a cellulosic component or is at least partially within a cellulosic matrix. The pectin component can be characterized by reference to its percent galacturonic acid (“% GA”) relative to the gelling fiber material. The % GA is used as a proxy for the total pectin content of the gelling citrus fiber material, or as a proxy for the percent of the gelling citrus fiber material that is the pectin component.

Reference in this specification to “de-esterification” and its grammatic variants means a chemical reaction that removes at least some of the methyl-ester groups from a pectin component or pectin compared to a raw material. While a pectin component may be de-esterified to have essentially no methyl-ester groups, preferably, as described in this specification, de-esterified pectin components have a substantial degree of esterification.

The gelling citrus fibers can be evaluated by their capability to form a gel having a defined gel strength. For purposes of comparison all gel strengths are measured using a “test gel” from a defined aqueous solution using a defined method. Reference in this specification to a “test gel” refers to gels made using the following formula and method.

Within this specification, test gels are made using the formula of Table 1.

TABLE 1
Test Gel Formula

| Ingredient | Fraction (%) |
|---|---|
| Gelling Citrus Fiber Material | 1.98 |
| Filtered tap water 1 | 54.40 |
| Sodium hexametaphosphate, | 0.05 |
| technical grade granular | |
| (NaPO₃)₆ | |
| Sugar | 29.67 |
| Hydrochloric acid, 10% | 0.25 |
| | (or as needed) |
| Calcium hydrogen phosphate, | 0.20 |
| anhydrous, 98% minimum | |
| Filtered tap water 2 | 4.95 |
| Glucono-delta-lactone | 1.09 |
| (D-gluconic acid lactone) | |
| Filtered tap water 3 | 6.18 |
| Filtered tap water 4 | 1.24 |
| Total | 100 |

Within this specification, tests gels are made using the following method. Note that filtered tap water 1 through 4 refer to adding filtered tap water at four different times in the process in the amount said, otherwise there is no difference in the filtered tap water 1 through 4. The filter is a standard drinking. Filtered tap water 1 is weighed and placed in a plastic beaker with a stir bar. The fiber is weighed and dispersed while stirring in the filtered tap water 1. The mixture is stirred for about 15 minutes. Sodium hexametaphosphate and sugar are weighed and added to the dispersion. The pH of the mixture is then adjusted (as needed) to pH 4 using hydrochloric acid, dropwise, using a plastic pipette. The mixture is then transferred to a pre-weighed stainless-steel beaker (600 ml) and heated in the water bath while stirring until 70-80° C. The mixture is held in the bath for 10 minutes after reaching the set temperature.

In a separate plastic beaker, mix the pre-weighed filtered tap water 2 and calcium hydrogen phosphate together. The calcium solution is added to the fiber mixture after shaking.

In another separate plastic beaker, the filtered tap water 3 and the glucono-delta-lactone are pre-weighed and mixed together to dissolve the lactone. After mixing, the solution is added to the fiber mixture. The filtered tap water 4 is weighed and used to wash off any lactone or calcium mixture left on the beakers. The washings are added to the fiber mixture. The fiber mixture is removed from the water bath and weighed. For a 100 g formulation, the total weight of the solution is around 100 g. If not, moisture is added back using filtered tap water and allowed to cool down at ambient temperature for 24 hours.

Use of “about” to modify a number is meant to include the number recited plus or minus 10%. Where legally permissible recitation of a value in a claim means about the value. Use of about in a claim or in the specification is not intended to limit the full scope of covered equivalents.

Recitation of the indefinite article “a” or the definite article “the” is meant to mean one or more unless the context clearly dictates otherwise.

While certain embodiments have been illustrated and described, a person with ordinary skill in the art, after reading the foregoing specification, can effect changes, substitutions of equivalents and other types of alterations to the methods, and of the present technology. Each aspect and embodiment described above can also have included or incorporated therewith such variations or aspects as disclosed regarding any or all the other aspects and embodiments.

The present technology is also not to be limited in terms of the aspects described herein, which are intended as single illustrations of individual aspects of the present technology. Many modifications and variations of this present technology can be made without departing from its spirit and scope, as will be apparent to those skilled in the art. Functionally equivalent methods within the scope of the present technology, in addition to those enumerated herein, will be apparent to those skilled in the art from the foregoing descriptions. Such modifications and variations are intended to fall within the scope of the appended claims. It is to be understood that this present technology is not limited to methods, conjugates, reagents, compounds, compositions, labeled compounds or biological systems, which can, of course, vary. All methods described herein can be performed in any suitable order unless otherwise indicated herein or otherwise clearly contradicted by context. It is also to be understood that the terminology used herein is for the purpose of describing aspects only and is not intended to be limiting. Thus, it is intended that the specification be considered as exemplary only with the breadth, scope and spirit of the present technology indicated only by the appended claims, definitions therein and any equivalents thereof. No language in the specification should be construed as indicating any non-claimed element as essential.

The embodiments illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

In addition, where features or aspects of the disclosure are described in terms of Markush groups, those skilled in the art will recognize that the disclosure is also thereby described in terms of any individual member or subgroup of members of the Markush group. Each of the narrower species and subgeneric groupings falling within the generic disclosure also form part of the technology. This includes the generic description of the technology with a proviso or negative limitation removing any subject matter from the genus, regardless of whether the excised material is specifically recited herein.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member, and each separate value is incorporated into the specification as if it were individually recited herein.

The technology disclosed in this specification is further described with reference to the following non-limiting aspects.

1. A gelling citrus fiber material comprising: a) a cellulosic component and b) an associated pectin component in an amount of from 40% to 50% (% galacturonic acid (% GA)), or from about 40% to about 48%, or about 40% to about 46%, or about 42% to about 48%, or about 42% to about 46%; the pectin component having a degree of esterification (% DE) of from about 10% to about 80%; and the gelling citrus fiber material having a molecular weight from about 50 kDa to about 275 kDa; wherein, optionally, the gelling citrus fiber material is obtained from citrus peel.

2. The gelling citrus fiber material of claim 1 wherein the pectin component has a degree of esterification selected from the group consisting of: from about 30% to about 45% (% DE), or from about 35% to about 45%, or from about 37% to about 45%; from about 46% to about 55% (% DE), or from about 47% to about 52%, or from about 47% to about 50%; from about 10% to about 20% (% DE), or from about 10% to about 18%, or from about 10% to about 15%; and from about 60% to about 65% (% DE), or from about 60% to about 63%.

3. The gelling citrus fiber material of claim 1 or 2 wherein the material has a molecular weight selected from the group consisting of: from about 50 to about 200 kDa, or from about 50 to about 150 kDa, or from about 50 to about 125 kDa, or from about 50 to about 100 kDa; from about 200 kDa to about 300 kDa, or from about 210 kDa to about 275 kDa, or from about 210 kDa to about 265 kDa, or from about 225 kDa to about 265 kDa, or from about 230 kDa to about 260 kDa; and from 100 kDa to about 200 kDa, or from about 100 kDa to about 150 kDa, or from about 100 kDa to about 125 kDa.

4. The gelling citrus fiber material of any one of claims 1 to 3 wherein: the degree of esterification of the pectin component is from about 30% to about 45% (% DE), or from about 35% to about 45%, or from about 37% to about 45%; and the molecular weight of the material is from about 50 to about 200 kDa, or from about 50 to about 150 kDa, or from about 50 to about 125 kDa, or from about 50 to about 100 kDa.

5. The gelling citrus fiber material of any one of claims 1 to 4 wherein: the degree of esterification in the pectin component is from about 46% to about 55% (% DE) or from about 47% to about 52%, or from about 47% to about 50%; and the molecular weight of the material is from about 200 kDa to about 300 kDa, or from about 210 kDa to about 275 kDa, or from about 210 kDa, to about 265 kDa, or from about 225 kDa, to about 265 kDa, or from about 230 kDa to about 260 kDa.

6. The gelling citrus fiber material of any one of claims 1 to 5 wherein: the degree of esterification is from about 10% to about 20% (% DE), or from about 10% to about 18%, or from about 10% to about 15%; and the molecular weight of the material is from 100 kDa to about 200 kDa, or from about 100 kDa to about 150 kDa, or from about 100 kDa to about 125 kDa.

7. The gelling citrus fiber material of any one of claims 1 to 6 wherein the degree of esterification of the pectin component is from about 60% to about 65% (% DE), or from about 60% to about 63%; and the molecular weight of the material is from 100 kDa to about 200 kDa, or from about 100 kDa to about 150 kDa, or from about 100 kDa to about 125 kDa.

8. The gelling citrus fiber material of any one of claims 1 to 7 capable of forming a gel in an aqueous solution when used in an amount of from about 0.5% to about 5% (wt % of the gel), or when used in an amount of from about 1.5% to 4.5%, or from about 2.5% to about 3.5%.

9. The gelling citrus fiber material of any one of claim 1 to 8 being capable of forming a test gel having a gel strength selected from the group consisting of: greater than about 200 g, or from about 200 g to about 500 g, or from about 225 g to about 500 g, or from about 275 g to about 500 g, or from about 300 g to about 500 g, or from about 300 g to about 400 g; less than about 200 g, or from about 100 g to about 200 g, or from about 110 g to about 180 g, or from about 125 g to about 175 g, or from about 130 g to about 170 g; and less than about 100 g or from about 10 g to about 100 g, or from about 20 g to about 100 g, or from about 25 g, to about 100 g, or from about 25 g to about to about 80 g, 25 g to about 75 g.

10. The gelling citrus fiber material of any one of claims 1 to 9 wherein: the degree of esterification of the pectin component is from about 30% to about 45% (% DE), or from about 35% to about 45%, or from about 37% to about 45%; the molecular weight of gelling citrus fiber material is from about 50 to about 200 kDa, or from about 50 to about 150 kDa, or from about 50 to about 125 kDa, or from about 50 to about 100 kDa; and the material can form a test gel having a gel strength greater than about 200 g, or from about 200 g to about 500 g, or from about 225 g to about 500 g, or from about 275 g to about 500 g or from about 300 g to about 500 g, or from about 300 g to about 400 g.

11. The gelling citrus fiber of any one of claims 1 to 10 wherein: the degree of esterification in the pectin component is from about 46% to about 55% (% DE), or from about 47% to about 52%, or from about 47% to about 50%; and the molecular weight of the gelling citrus fiber material is from about 200 kDa to about 300 kDA, or from about 210 kDa to about 275 kDa, or from about 210 kDa to about 265 kDa, or from about 225 kDa to about 265 kDa, or from about 230 kDa to about 260 kDa; and it can form a test gel having a gel strength of less than about 200 g, or from about 100 g to about 200 g, or from about 110 g to about 180 g, or from about 125 g to about 175 g, or from about 130 g to about 170 g.

12. The gelling citrus fiber of any one of claims 1 to 11 wherein: the degree of esterification is from about 10% to about 20% (% DE), or from about 10% to about 18%, or from about 10% to about 15%; the molecular weight of the material is from 100 kDa to about 200 kDa, or from about 100 kDa to about 150 kDa, or from about 100 kDa to about 125 kDa; and the fiber can form a test gel is less than about 100 g or from about 10 g to about 100 g, or from about 20 g to about 100 g, or from about 25 g, to about 100 g, or from about 25 g to about to about 80 g, 25 g to about 75 g.

13. The gelling citrus fiber material of any one of claims 1 to 12 wherein: the degree of esterification of the pectin component is from about 60% to about 65% (% DE), or from about 60% to about 63%; and the molecular weight of the material is from 100 kDa to about 200 kDa, or from about 100 kDa to about 150 kDa, or from about 100 kDa to about 125 kDa; and the gel strength of the test gel is less than about 100 g, or from about 10 g to about 100 g, or from about 20 g to about 100 g, or from about 25 g to about 100 g, or from about 25 g to about to about 80 g, 25 g to about 75 g.

14. The gelling citrus fiber material of any one of claims 1 to 13 wherein the gel strength of the test gel is measured at a temperature of about 20° C.

15. The gelling citrus fiber material of any one of claim 1 to 14 wherein the cellulosic component forms a matrix and at least a portion of the pectin component is within the matrix.

16. A method for making a gelling citrus fiber material as described in any foregoing claim comprising: mixing a comminuted citrus peel comprising a pectin component and a cellulosic component with an acidic solution to obtain an acid washed citrus peel; mixing the acid washed citrus peel with an alkaline solution to reduce the degree of esterification (% DE) of the pectin component thereby obtaining de-esterified citrus peel; and recovering the de-esterified citrus peel to obtain the gelling citrus fiber material.

17. The method of claim 16 further comprising mixing the de-esterified citrus peel with a solution comprising an organic solvent to wash the de-esterified citrus peel, wherein, optionally, the organic solvent is an alcohol thereby obtaining a gelling citrus fiber material, and wherein, optionally, the de-esterified citrus peel is washed with an organic solvent more than once, preferably, three times.

18. The method of claim 16 or 17 further comprising prior to step a) obtaining a citrus peel material and the milling citrus peel material to obtain the comminuted citrus peel, wherein, optionally, the comminuted citrus peel is rehydrated prior to mixing with an acidic solution.

19. The method of any one of claims 16 to 18 wherein the acidic solution has a pH of less than 3, or from about 1.5 to about 2.5.

20. The method of any one of claims 16 to 19 wherein the comminuted citrus peel is mixed with the acidic solution for from about 10 minutes to about 90 minutes.

21. The method of any one of claims 16 to 20 wherein the comminuted citrus peel is mixed with the acidic solution for a time selected from the group consisting of: from about 10 minutes to about 30 minutes; from about 30 minutes to about 50 minutes; and from about 50 minutes to about 70 minutes.

22. The method of any one of claims 16 to 21 wherein the alkaline solution has a pH of greater than about 8 or greater than about 8.5, or from 8.5 to about 11, or from about 9 to about 10.

23. The method of any one claims 16 to 22 wherein the acid washed citrus peel is mixed with the alkaline solution at a temperature from about 1° C. to about 30° C.

24. The method of any one of claims 16 to 23 wherein the acid washed citrus peel is mixed with the alkaline solution at a temperature selected from the group consisting of: from about 10 to about 10° C., or from about 3° C. to about 7° C.; from about 10° C. to about 20° C. or from about 12° C. to about 17° C.; and from about 20° C. to about 30° C. or from about 22° C. to about 27° C.

25. A method of monitoring a chemical reaction involving a material comprising a pectin component and a cellulosic component, the method comprising: recording a spectrum of the material; and evaluating the spectrum against a model that correlates the spectrum against a second parameter of one or more of the pectin component or cellulosic component containing cellulosic material wherein the spectrum is evaluated at least within a wavenumber range selected from the group consisting of: a wavenumber range from about 1400 to about 845 cm⁻¹, one or more wavenumber ranges selected of the group consisting of (A) about 1400 to about 1050 cm⁻¹, (B) about 1050 to about 975 cm⁻¹, (C) about 975 to about 875 cm⁻¹, and (D) about 875 and about 845 cm¹, and one or more wave number ranges selected from the group consisting of (A) about 1095 to about 1070 cm⁻¹, (B) about 1050 to about 1020 cm⁻¹, (C) about 975 to about 895 cm⁻¹, and (D) about 875 to about 845 cm⁻¹; wherein, preferably, the chemical reaction converts the material to a gelling citrus fiber.

26. The method of claim 25 wherein the spectrum is measured using infrared spectroscopy, wherein, preferably, using Fourier transform infrared spectroscopy.

27. The method of claim 25 or 26 wherein the second parameter is selected from the group of consisting degree of esterification, total pectin component content, and molecular weight.

28. The method of any one of claims 25 to 27 wherein the spectrum is recorded in a reaction vessel during a chemical reaction that alters the pectin component containing cellulosic material wherein, optionally, the chemical reaction is altering one or more of: degree of esterification, total pectin component content, or molecular weight of the pectin component containing cellulosic material.

29. The method of any one of claims 25 to 28 wherein the spectrum is measured during a process as described any of the foregoing claim, wherein, preferably, the spectrum is measured at least during the de-esterification step.

30. The method of any one of claims 25 to 29 wherein the spectrum is recorded by measuring a sample collected from a reaction vessel wherein, optionally, the chemical reaction is altering one or more of: degree of esterification, total pectin component content, or molecular weight of the pectin component containing cellulosic material.

31. The method of any one of claims 25 to 30 wherein the spectrum is recorded from a sample obtained during a reaction as described in any foregoing claim, wherein, preferably the spectrum is the measured from a sample taken during the de-esterification step.

32. The method any one of claim 25 to 31 further comprising adjusting one parameter of the chemical reaction based on the evaluation of the spectrum; wherein, optionally the one parameter is associated with de-esterifying the material.

33. The method of any one of claims 25 to 32 further comprising recovering a gelling citrus fiber from the chemical reaction, wherein the gelling citrus fiber is as described in claims 1-15.

34. Use of the gelling citrus fiber material as described in any foregoing claim to modify the texture of a composition, wherein, optionally, the composition is a food composition.

35. Use of the gelling citrus fiber material as described claim 34 wherein the gelling citrus fiber is used as a gelling agent.

36. Use of the gelling citrus fiber material as described in claim 34 or 35 wherein the gelling citrus fiber material is used in an amount from about 0.1% to about 10% or from about 0.5% to about 5% (wt % of composition), or when used in an amount of from about 1.5% to 4.5%, or from about 2.5% to about 3.5%.

37. A composition comprising: a gelling citrus fiber material as described in any one of the foregoing claims and a second ingredient; wherein, optionally, the composition is a food composition.

38. The composition of claim 37 wherein the second ingredient is an aqueous ingredient, and wherein the gelling citrus fiber material is used in an amount of from about 0.1% to about 10%, or from about 0.5% to about 5% (wt % of the composition), or when used in an amount of from about 1.5% to 4.5%, or from about 2.5% to about 3.5%.

39. A gelling fiber material comprising: a) a cellulosic component and b) an associated pectin component in an amount of from 40% to 50% (% galacturonic acid (% GA)), or from about 40% to about 48%, or about 40% to about 46%, or about 42% to about 48%, or about 42% to about 46%; the pectin component having a degree of esterification (% DE) of from about 10% to about 80%; and the gelling fiber material having a molecular weight from about 50 kDa to about 275 kDa.

The technology disclosed in this specification is further described with reference to the following non-limiting examples.

### EXAMPLE 1—METHODS

Gelling citrus fiber materials were prepared and were measured for percent galacturonic acid (“% GA”), degree of esterification (“% DE”), and molecular weight, measured in Daltons (“Da”). Solutions were also made using the prepared the gelling citrus fiber materials and were tested for gel strength, measured in grams (“g”). As said in this specification, % GA is used as a proxy for pectin content of the gelling citrus fiber material and so is a proxy for the percent of the gelling citrus fiber material that is the pectin component.

Degree of esterification (% DE) of pectin containing cellulosic material and pectin content (% GA) of the pectin containing cellulosic material were measured using a titration method. The method can be divided into two parts: (1) washing the material and (2) double titration. Washing the sample removes any salts, sugars and counter-ions using acidic alcohol to ensure all the pectin is either in the esterified form or present as free acid. The first titration is used to determine the free acid groups and the neutral solution can then be used in the second titration method proposed by Schultz (1965).

Steps for washing the material follow. The dry powder sample is tested first for moisture content before washing. An acidic alcohol solution is prepared by mixing isopropanol (600 m) with water (350 ml) and concentrated hydrochloric acid (50 ml). About 10 grams of sample was suspended in 150 ml acidic alcohol and stirred on a magnetic stirrer for 15 minutes. The slurry was then filtered on a Buchner funnel and resuspended in another 150 ml aliquot of the acidic alcohol solution. This step was repeated until all the acidic alcohol was used. The powder was then resuspended in 150 ml of 60/40 isopropanol water mixture, allowed to soak for five minutes and then removed of liquid using a vacuum. This step was repeated three times. The sample was then resuspended again in 150 ml pure isopropanol mixture, allowed to soak for five minutes and then removed of liquid using a vacuum. This step was repeated three times. Using a filter paper on the funnel, liquid and air is drawn using vacuum until the sample no longer smells of alcohol. The powder was then dried overnight at 45° C.

Steps of double titration follow. For the first titration, a 1.0-gram sample of the dry material was weighed. The sample is then suspended in 10 ml of isopropanol and then dispersed in 150 ml of distilled water. More water was added if the sample becomes very thick. Using a magnetic stirrer, the dispersion was stirred for one hour and the pH was measured. The sample was titrated against a sodium hydroxide solution (0.1 M) to pH 7. This measured the free acid groups. This was recorded as the first titre. For the second titration, about 40 ml of sodium hydroxide (0.1 M) was pipetted into a plastic beaker and stirred for 30 mins. This removes any ester groups. The sample was then titrated with hydrochloric acid (0.1 M) to pH 7 and recorded as titre 2. The degree of esterification (% DE) is the molar ratio of ester to total GA.

The weight percent of galacturonic acid (% GA) is the weight of the pectic acid and pectin (ester) combined divided by the dry weight sample of the sample:

$$\% G A = \frac{( pectin ester groups in grams ) + ( free pectic acid in grams )}{fiber sample , dry weight in grams} \times 100$$

The % DE is the molar ratio of ester to total % GA which is:

$$\% D E = \frac{moles alkali consumed by sample}{moles alkali consumed by sample + moles free pectic acid}$$

Method for measuring molecular weight using gel permeation chromatography (GPC). Various equipment can be used. Reported samples were measured using WATERS Alliance GPCV2000 with refractive index detector or an AGILENT1260 Infinity II High temperature GPC with refractive index detector. Reported molecular weights were weighted average molecular weights, that is the average of the weight fractions across the observed distribution and relative to Pullulan standards.

Method for measuring gel strength—After setting, the gel strengths were measured using a texture analyzer (Texture Technologies) using an AOAC probe (T10) at advanced at 0.5 mm/sec for 20 mm distance with a trigger force of 1 g (where rigger force is the minimum forced needed to initiate recording data). The gel strength values were measured from the first break (break force in grams). The trigger force is the force point that the instrument has to detect/reach before the measurement starts.

### EXAMPLE 2—ILLUSTRATIVE PROCESS FOR MAKING OF GELLING CITRUS FIBER MATERIAL

Whole dried citrus peels (519.3 g) were dry milled using a Fitzmill through a 1.5 mm screen followed by kitchen mill to obtain fine particle size. The peels were then mixed into tap water (25° C., 6266 g) while stirring using an overhead mixer. The mixture (7% solids) was stirred to rehydrate for 1 hour at 25° C. The mixture was dewatered using Buchner funnel, flask and grade 113 wet strength filter paper to obtain wet peels (2331 g) and filtrate (4390 g). The wet peels were reslurried to 7% solids by adding tap water (25° C., 4454 g). The acidity of the slurry was adjusted to pH 1.7 (170.7 g of 3N HCl). The slurry was held at 25° C. for 1 hour. The mixture was again dewatered obtaining wet acidified peels (4320 g) and filtrate (2190.4 g). The wet acidified peels were reslurried to 7% solids by adding tap water (25° C., 2465 g). The mixture was agitated for 30 minutes during the water wash.

The mixture was dewatered again to obtain a clean, washed citrus peel (2426 g) and filtrate (2190.4 g). The clean peels were reslurried to 7% solids by adding previously refrigerated tap water (4595 g) and the mixture chilled to 5° C. The reaction mixture was monitored with an infrared spectroscopy (“IR”) probe inserted into the reaction vessel. Sodium carbonate monohydrate (27 g) was added to the mixture to adjust it to pH 9. The mixture was maintained at pH 9 for about 18 hours at 4° C. using a pH controller and peristaltic pump and 25% sodium carbonate solution (25.12 g), the mixture was then taken and neutralized to pH 4-5 by adding citric acid monohydrate (1 hr: 14.52 g; 18 hr: 84.06 g).

The recovered sample was washed with alcohol. An equal amount of alcohol was stirred into the sample for 20 minutes. The mixture was dewatered using a Buchner funnel and solvent-rated vacuum pump. The washing was performed 2 more times for a total of 3 washes. The dried orange peel raw material and products were then placed in an oven and dried overnight at 40° C.

The sample made by the illustrative method, is called Sample 1 in this specification. It had a total pectin content of 45.49±0.28 (% GA), percent degree of esterification (% DE) of 62.56±0.60, and a molecular weight of 142,000 (Da).

### EXAMPLE 3—ILLUSTRATIVE PROCESS FOR MAKING GELS FROM GELLING CITRUS FIBER MATERIALS

Test gels were made as defined, but for convenience the formula (as said in Table 1) and method are repeated below.

TABLE 2
Illustrative Gel Formula

| Ingredient | Fraction (%) |
|---|---|
| Gelling Citrus Fiber Material | 1.98 |
| Filtered tap water 1 | 54.40 |
| Sodium hexametaphosphate, | 0.05 |
| technical grade granular | |
| (NaPO₃)₆ | |
| Sugar | 29.67 |
| Hydrochloric acid, 10% | 0.25 |
| | (or as needed) |
| Calcium hydrogen phosphate, | 0.20 |
| anhydrous, 98% minimum | |
| Filtered tap water 2 | 4.95 |
| Glucono-delta-lactone | 1.09 |
| (D-gluconic acid lactone) | |
| Filtered tap water 3 | 6.18 |
| Filtered tap water 4 | 1.24 |
| Total | 100 |

Note in the formula that that filtered tap water 1 through 4 refer to adding filtered tap water at four different times in the process in the amount said, otherwise there is no difference in the filtered tap water 1 through 4. The filter used was a standard drinking water filter. Gels were made as follows. Filtered tap water 1 was weighed and placed in a plastic beaker with a stir bar. The fiber was weighed and dispersed while stirring in the filtered tap water 1. The mixture was stirred for about 15 minutes. Sodium hexametaphosphate and sugar were weighed and added to the dispersion. The pH of the mixture was then adjusted (as needed) to pH 4 using hydrochloric acid, dropwise, using a plastic pipette. The mixture was then transferred to a pre-weighed stainless-steel beaker (600 ml) and heated in the water bath while stirring until 70-80° C. The mixture was held in the bath for 10 minutes after reaching the set temperature.

In a separate plastic beaker, the pre-weighed filtered tap water 2 and calcium hydrogen phosphate were mixed together. The calcium solution was added to the fiber mixture after shaking.

In another separate plastic beaker, the filtered tap water 3 and the glucono-delta-lactone were pre-weighed and mixed together to dissolve the lactone. After mixing, the solution was added to the fiber mixture. The filtered tap water 4 was weighed and used to wash off any lactone or calcium mixture left on the beakers. The washings were added to the fiber mixture. The fiber mixture was removed from the water bath and weighed. For a 100 g formulation, the total weight of the solution was around 100 g. If not, moisture was added back using filtered tap water. The fiber mixture was then divided into 4 equal parts and allowed to cool down at ambient temperature for 24 hours.

### EXAMPLE 4—COMPARISON OF GELLING CITRUS FIBER MATERIALS

Various gelling citrus fiber materials were made by varying the process of Example 3. The obtained samples were tested for pectin content (SGA), degree of esterification (hDE), molecular weight (Da) (weight average Mw). The obtained gelling citrus fibers were used to form solutions as described in Example 1 and observed to determine whether the solution formed a gel, and if so what the gel strength (g) was. Properties of the obtained gelling citrus fibers and the gel strength of gels obtained from the gelling citrus fibers are presented in Table 3.

TABLE 3
Properties of Gelling Citrus Fiber Materials and Gels Obtained Therefrom

| | | Degree of | Weight Average | Gel |
|---|---|---|---|---|
| | Total Pectin | Esterification | Molecular Weight | Strength |
| Sample | (% GA) | (% DE) | (Da) | (g) |
| Sample 0* | 45.56 | 63.04 | 242,315 | Did not gel |
| Sample 1 | 45.49 | 62.56 | 142,000 | 49.27 |
| Sample 2 | 46.06 | 45.45 | 177,248 | 309.65 |
| Sample 3 | 45.35 | 49.91 | 258,690 | 134.22 |
| Sample 4 | 43.11 | 11.12 | 110,493 | 28.52 |
| Sample 6 | 40.60 | 16.44 | 118,830 | 93.86 |
| Sample 7 | 41.62 | 14.69 | 112,035 | 53.09 |
| Sample 8 | 46.80 | 37.73 | 58,570 | 398.70 |
| Sample 9 | 42.02 | 42.11 | 101,742 | 235.72 |
| Sample 10 | 44.71 | 14.44 | 119,286 | 122.78 |
| Sample 11 | 48.28 | 46.12 | 244,740 | 192.42 |
| Sample 12 | 45.20 | 62.88 | 106,582 | 117.01 |
| Sample 13 | 42.41 | 52.79 | 169,185 | 163.52 |
| Sample 14 | 45.17 | 61.54 | 170,000 | 10.41 |
| Sample 15 | 41.58 | 48.59 | 237,994 | 137.29 |

*Unmodified comminuted orange peel.

Samples 0 to 15 were made by varying the temperature of the de-esterification reaction, varying the pH of the de-esterification reaction, the length of the acid wash, and the pH of the acid wash. The relevant conditions used to make samples 0 to 15 are reported in Table 4.

TABLE 4
Reaction Conditions for Gelling Citrus Fiber Samples 0 to 15

| | De- | | | |
|---|---|---|---|---|
| | esterification | pH of de- | Length of | Acid |
| | reaction temp | esterification | acid wash | wash |
| Sample | (° C.) | reaction | (minutes) | pH |
| Sample 0 | N/A | N/A | N/A | N/A |
| Sample 1 | 5 | 9 | 60 | 1.7 |
| Sample 2 | 15 | 9.5 | 40 | 2.1 |
| Sample 3 | 5 | 10 | 60 | 2.5 |
| Sample 4 | 25 | 10 | 20 | 1.7 |
| Sample 5 | 5 | 10 | 20 | 2.5 |
| Sample 6 | 25 | 10 | 60 | 2.5 |
| Sample 7 | 25 | 10 | 60 | 1.7 |
| Sample 8 | 25 | 9 | 60 | 1.7 |
| Sample 9 | 25 | 9 | 20 | 1.7 |
| Sample 10 | 25 | 10 | 20 | 2.5 |
| Sample 11 | 5 | 10 | 60 | 1.7 |
| Sample 12 | 5 | 9 | 20 | 1.7 |
| Sample 13 | 15 | 9.5 | 40 | 2.1 |
| Sample 14 | 5 | 9 | 20 | 2.5 |
| Sample 15 | 5 | 10 | 20 | 1.7 |

To emphasize relationships among parameters, Table 5 below repeats the data from Table 3 but is sorted from high degree of esterification to low degree of esterification. Cohorts are generated to group similar gel strengths.

TABLE 5
Properties of Gelling Citrus Fiber Materials and Gels Obtained
Therefrom (Arranged by Degree of Esterification)

| | | Total | Degree of | Average | Gel |
|---|---|---|---|---|---|
| | | Pectin | Esterification | Molecular | Strength |
| Cohorts | Sample | (% GA) | (% DE) | Weight (Da) | (g) |
| | Sample 0* | 45.56 | 63.04 | 242,315 | Did not gel |
| Cohort 1 | Sample 12 | 45.20 | 62.88 | 106,582 | 117.01 |
| | Sample 1 | 45.49 | 62.56 | 142,000 | 49.29 |
| | Sample 14 | 45.17 | 61.54 | 170,000 | 10.41 |
| Cohort 2 | Sample 13 | 42.41 | 52.79 | 169,185 | 163.52 |
| | Sample 3 | 45.35 | 49.91 | 258,690 | 134.22 |
| | Sample 15 | 41.58 | 48.59 | 237,994 | 137.29 |
| Cohort 3 | Sample 11 | 48.28 | 46.12 | 244,740 | 192.42 |
| Cohort 4 | Sample 2 | 46.06 | 45.45 | 177,248 | 309.65 |
| | Sample 9 | 42.02 | 42.11 | 101,742 | 235.72 |
| | Sample 8 | 46.80 | 37.73 | 58,570 | 398.70 |
| Cohort 5 | Sample 6 | 40.60 | 16.44 | 118,830 | 93.86 |
| | Sample 7 | 41.62 | 14.69 | 112,035 | 53.09 |
| | Sample 10 | 44.71 | 14.44 | 119,286 | 122.78 |
| | Sample 4 | 43.11 | 11.12 | 110,493 | 28.52 |

*Unmodified comminuted orange peel.

Cohort 4 has gelling citrus fiber materials that formed the strongest gels, above about 200 g. The gelling citrus fiber materials of cohort 4 generally had a moderate degree of esterification, between about 35% and 450%, and had a moderate molecular weight to low molecular weight, 50,000 and 200,000 Da.

Cohort 2 had gelling citrus fiber materials that formed moderately strong gels, between 100 and 200 g, are in cohort 2. The gelling fiber materials of cohort 2 had generally higher degree of esterification, between 45% and 55%, than gelling citrus fiber materials of cohort 4. The gelling fiber materials of cohort 3 also had generally higher molecular weight, above about 200,000 Da, compared cohort 4.

The gelling citrus fiber materials that formed the weakest gels were in cohort 1 and cohort 5. The gelling citrus fiber materials of cohort 5 had a low degree of esterification, less than about 20%. The gelling citrus fiber materials of cohort 1 had a high degree of esterification, above about 60%.

The amount of pectin (% GA) was similar among samples compared to differences in degree of esterification and molecular weight.

### EXAMPLE 5—FUNCTIONAL EFFECT OF ACID WASH

Acid washing was found important for obtaining a gelling citrus fiber that forms strong gels. Effect of acid is seen by preparing samples as follows. Samples were prepared by taking whole dried citrus peel, done by dry milling followed by kitchen milling to obtain a fine particle size. The peels were then mixed into tap water while stirring using an overhead mixer. The mixture was stirred to rehydrate for 6 minutes at 25° C. The mixture was dewatered using a Buchner funnel, flask and grade 113 wet strength filter paper to obtain wet peels, and the filtrate collected and weighed. The rehydrated peels were reslurried by adding tap water (25° C.).

In this experiment, Sample E146 was not acid washed, but Sample E145 was acid washed. For acid washing, the acidity of the slurry was adjusted to pH 2.5 and held at 25° C. for 20 minutes. The mixture was again dewatered obtaining wet acidified peels and filtrate. The wet acidified peels were reslurried by adding unfiltered tap water (25° C.). Following the acid wash, Sample E145 and E146 were processed using the same reactions conditions reaction conditions. Sodium carbonate monohydrate was added to the mixture to raise pH to pH 10. The mixture was maintained at pH 10 for 2 hours at 25° C. using a pH controller and peristaltic pump and 25% sodium carbonate solution. The reaction mixture was then pH adjusted to pH 4-5 by adding citric acid monohydrate. The mixture was then alcohol washed. An equal amount of alcohol was stirred into the sample for 20 minutes. The mixture was dewatered using a Buchner funnel and solvent-rated vacuum pump. The washing was performed 2 more times for a total of 3 washes. The dried orange peel raw material and products were then placed in an oven and dried overnight at 40° C. The dried products were tested for total pectin, degree of esterification (DE) and gel strength. Recovered material was used to form gels as described in Example 2. Gels were measured for gel strength using the method described in Example 1.

Results are reported in Table 6 showing that although samples E145 and E146 had similar total pectin and degree of esterification, the acid washed sample (E145) formed much stronger gels. Samples E145 and E146 were also compared to unprocessed dried orange peel.

TABLE 6
Effect of Acid Wash on Gel Strength
Obtainable from Gelling Citrus Fiber

| | Acid | Total Pectin | % | Gel Strength |
|---|---|---|---|---|
| Sample Name | Wash | (% GA) | DE | (g force) |
| Dried Orange Peel | N/A | 45.56 | 63.04 | Did not gel |
| E146-2 hr | No | 44.47 | 36.65 | 62.41 |
| E145-2 hr | Yes | 46.07 | 32.09 | 256.63 |

### EXAMPLE 6—MODELING AND PROCESS CONTROL OF DE-ESTERIFICATION REACTION

Reference is made to the reaction described in Example 1. Notably, as said, the reaction mixture was monitored with an IR probe inserted into the reaction vessel. IR spectrums measured using Fourier Transform Infrared Spectroscopy (“FTIR”). An FTIR spectrometer (Bruker Optics, Matrix MF) coupled with a diamond attenuated total reflectance (“ATR”) fiber probe (Bruker Optics, IN356-EX) was installed next to the reaction tank during the materials processing and de-esterification reaction steps to collect a spectrum every 30 seconds. The spectrums were collected from wavenumber range of 3500-650 cm⁻¹ having 4 cm⁻¹ resolution. The probe (having a diameter of 12 mm, and overall fiber length of 2 m) was inserted and secured tightly in the vessel during the length of the reaction (up to 18 hours). The instrument and spectrums collection were controlled by OPUS software (Bruker Optics).

To develop an IR model for real time process monitoring, the in-line system was first used (for collecting IR spectrums) in a series of reactions (called training reactions) producing a wide range of de-esterified products. The in-process and final products of these training reactions were tested by the titration method described in this specification to determine actual degree of esterification. A Partial Least Squares (“PLS”) regression was formulated (using OPUS software) to correlate the collected in-line spectrums with the degree of esterification measured using the titration method in order to develop a model to predict degree of esterification from the comparison.

Once the model was developed, the model was tested in new reactions to validate the prediction performance of the model. To test/implement the developed model for in-line process monitoring, the II spectrums are collected during the de-esterification reaction, and the IR model is immediately applied (in real-time by OPUS software) on each spectrum to predict degree of esterification value at the time of collection. Samples were collected at time the JR model was applied and degree of esterification was measured using titration to determine measurement error of the prediction model. The IR model prediction and titration measurement of degree of esterification are reported in Table 7 below.

TABLE 7
Comparison of Degree of Esterification Predicted from
In-Line FTIR Model and Measured Using Titration

| | Degree of Esterification (% DE) | |
|---|---|---|
| Sample | In-line FTIR | Titration |
| Run 1 | 64.80 | 62.56 |
| Run 2 | 46.54 | 45.45 |
| Run 3 | 45.19 | 49.915 |
| Run 4 | 9.052 | 11.125 |
| Run 6 | 13.58 | 16.445 |
| Run 7 | 16.04 | 14.69 |
| Run 8 | 33.79 | 31.725 |
| Run 9 | 43.01 | 42.11 |
| Run 10 | 57.15 | 59.2 |
| Run 11 | 41.3 | 36.315 |
| Run 12 | 1.62 | 14.44 |
| Run 13 | 57.95 | 46.12 |
| Run 14 | 54.33 | 62.88 |
| Run 15 | 54.13 | 52.79 |
| Run 16 | 60.67 | 62.61 |
| Run 17 | 62.92 | 61.54 |
| Run 18 | 46.17 | 48.59 |

A second model was developed for rapid “offline” IR measurements meaning that the IR spectrums model can be applied to samples pulled from a reaction vessel instead of being measured within the reaction vessel allowing for faster degree of esterification calculation than is possible using titration measurement methods.

Training samples were obtained and measured for IR spectrums using a ThermoFisher Nicolet iS10 spectrometry with attenuated total reflectance (ATR) accessory (PIKE Technologies). System suitability (i.e. system boot and internal calibration) was measured using the built-in software and background spectrum was taken. Bench top FTIR is obtained as follows: about 0.025 g of powdered sample was placed over a diamond crystal probe. All scans were collected from wavenumber range of 4000-650 cm⁻¹ with 32 scans, 4 cm⁻¹ resolution and in triplicates. Spectrums models were developed from training runs using spectrums generated from in-line and end-product reaction samples correlated against the degree of esterification for such samples obtained using titration. A Partial Least Squares (PLS) regression was formulated to correlate the collected spectrums with the degree of esterification measured using the titration method to develop a model to predict degree of esterification from the comparison.

Once the model was developed, the model was tested in new reactions to validate the prediction performance of the model. To test/implement the developed model for off-line process monitoring, samples were collected during and at the end of each reaction, and scanned on the IR instrument, which applied the IR model to predict the degree of esterification. The same samples were also tested by titration and the predicted IR degree esterification values were compared to titration measured degree of esterification, in order to evaluate the validity of the IR model.

The IR model prediction and titration measurement of degree of esterification are reported in Table 8 below.

TABLE 8
Comparison of Degree of Esterification Predicted from Off-
Line (Sampled) FTIR Model and Measured Using Titration

| | Degree of Esterification (% DE) | |
|---|---|---|
| Sample | Off-line FTIR Method | Titration Method* |
| Run 3 | 50.12 | 50 |
| Run 4 | 11.79 | 11 |
| Run 7 | 13.78 | 15 |
| Run 9 | 39.75 | 42 |
| Run 12 | 17.77 | 14 |
| Run 13 | 47.60 | 46 |
| Run 14 | 62.11 | 63 |

*Values rounded to the nearest whole number.

With reference to Tables 7 and 8, models made as described accurately predicted the degree of esterification based on FTIR spectrums of pectin containing cellulosic materials as shown when validated against titration methods.

1. A gelling citrus fiber material comprising:
a) a cellulosic component and
b) an associated pectin component in an amount of from 40% to 50% (% galacturonic acid (% GA));
wherein the pectin component has a degree of esterification (% DE) of from about 10% to about 80%; and
wherein the gelling citrus fiber material has a molecular weight from about 50 kDa to about 275 kDa.

2. (canceled)

3. (canceled)

4. (canceled)

5. (canceled)

6. (canceled)

7. (canceled)

8. The gelling citrus fiber material of claim 1 capable of forming a gel in an aqueous solution when used in an amount of from about 0.5% to about 5% (wt % of the gel).

9. The gelling citrus fiber material of claim 1 being capable of forming a test gel having a gel strength from about 10 to about 400 q at 20° C. in an aqueous solution when used in an amount from about 0.5% to about 5% (wt % of the gel)

10. (canceled)

11. (canceled)

12. (canceled)

13. (canceled)

14. (canceled)

15. The gelling citrus fiber material of claim 1 wherein the cellulosic component forms a matrix and at least a portion of the pectin component is within the matrix.

16. A method for making a gelling citrus fiber material claim comprising:
a. mixing a comminuted citrus peel comprising a pectin component and a cellulosic component with an acidic solution to obtain an acid washed citrus peel;
b. mixing the acid washed citrus peel with an alkaline solution to reduce the degree of esterification (% DE) of the pectin component thereby obtaining de-esterified citrus peel; and
c. recovering the de-esterified citrus peel to obtain the gelling citrus fiber material.

17. The method of claim 16 further comprising mixing the de-esterified citrus peel with a solution comprising an organic solvent to wash the de-esterified citrus peel.

18. The method of claim 16 further comprising prior to step a) obtaining a citrus peel material and the milling citrus peel material to obtain the comminuted citrus peel.

19. The method of claim 16 wherein the acidic solution has a pH of less than 3 and the comminuted citrus peal is mixed with the acidic solution for a time from about 10 to about 70 minutes.

20. (canceled)

21. (canceled)

22. The method of claim 16 wherein the alkaline solution has a pH of greater than about 8.

23. The method of claim 16 wherein the acid washed citrus peel is mixed with the alkaline solution at a temperature from about 1° C. to about 30° C.

24. (canceled)

25. A method of making a gelling citrus fiber, the fiber comprising a pectin component and a cellulosic component, the method comprising:
a. recording a measured spectrum of the material;
b. and evaluating the spectrum against a model that correlates the spectrum against a second parameter of one or more of the pectin component or cellulosic component containing cellulosic material wherein the spectrum is evaluated at least within a wavenumber range selected from the group consisting of:
i. a wavenumber range from about 1400 to about 845 cm⁻¹.

26. The method of claim 25 wherein the spectrum is measured using infrared spectroscopy.

27. (canceled)

28. The method of claim 25 wherein the spectrum is measured in a reaction vessel during a chemical reaction that alters the pectin component containing cellulosic material and wherein, the chemical reaction is altering one or more of: degree of esterification, total pectin component content, or molecular weight of the pectin component containing cellulosic material.

29. The method of claim 25 wherein the spectrum is measured at least during a de-esterification step.

30. (canceled)

31. The method of claim 25 wherein the spectrum is measured from a sample obtained during taken during a de-esterification step.

32. The method claim 25 further comprising adjusting one parameter of the chemical reaction based on the evaluation of the spectrum.

33. (canceled)

34. (canceled)

35. (canceled)

36. (canceled)

37. A composition comprising: a gelling citrus fiber material and a second ingredient; wherein the gelling citrus fiber material comprises a) a cellulosic component and b) an associated pectin component in an amount of from 40% to 50% (% galacturonic acid (% GA)), the pectin component has a degree of esterification (% DE) of from about 10% to about 80% and the gelling citrus fiber material having a molecular weight from about 50 kDa to about 275 kDa.

38. The composition of claim 37 wherein the second ingredient is an aqueous ingredient, and wherein the gelling citrus fiber material is used in an amount of from about 0.1% to about 10%.

39. (canceled)
